(19) United States
(12) Patent Application Publication
(10) Pub. No.: US 2013/0008549 A1
(43) Pub. Date: Jan. 10, 2013

(54) REHABILITATION PIPE AND PIPE REHABILITATION METHOD EMPLOYING REHABILITATION PIPE

(76) Inventors: Ryoji SAKURADA, Akita-shi (JP); Akihiro Ishii, Akita-shi (JP); Takeshi Hasegawa, Hiratsuka-shi (JP)

(21) Appl. No.: 13/542,943

(22) Filed: Jul. 6, 2012

(30) Foreign Application Priority Data
Jul. 8, 2011 (JP) 2011-151765

(51) Int. Cl. F16L 55/16; F16L 55/18

(52) U.S. Cl. 138/98; 138/97

(57) ABSTRACT

Segments each comprising an internal surface panel and outer wall panels at the peripheral edges of the internal surface panel are linked together in the circumferential direction to constitute a pipe unit. A wire or a band of aramid fibers is attached to the pipe unit, and the pipe units with the wire or the band of aramid fibers attached thereto are linked in succession in the pipe length direction to assemble a rehabilitation pipe inside an existing pipe. The wire or band of aramid fiber has high tensile strength, and can be embedded within a solidified filler that fills the gap between an existing pipe and the rehabilitation pipe, and therefore a high-strength composite pipe can be constructed.

### BACKGROUND OF THE INVENTION

1. Field of the Invention

The present invention relates to a rehabilitation pipe adapted for use in repair of pipeline facilities and a pipe rehabilitation method using the rehabilitation pipe, which is assembled by linking segments in the circumferential direction and the pipe length direction.

2. Description of the Related Art

In cases where sewer pipes or other pipelines buried underground are aged, a pipe lining method is employed in which the inside peripheral surface is lined to repair the pipeline without having to excavate the pipeline from the ground.

In the above-mentioned pipe lining method, a pipe lining material is used which has a flexible tubular resin-absorbing material impregnated with an uncured thermosetting resin therein. The pipe lining material is inserted into the pipeline to be lined while being everted through fluid pressure, and it is pressed against the inside peripheral wall of the pipeline by fluid pressure and heated by any method to cure the thermosetting resin impregnated therein, thereby forming a plastic pipe inside the pipeline for repairing thereof.

A method for rehabilitating a pipeline using segments is also known from Japanese Patent Laid-Open Publication No. 2003-286742. The segment is an integrally molded block-shaped member made of a plastic material and composed of an internal surface panel, and side and end panels provided vertically at the peripheral edges thereof. The segments are linked together in the circumferential direction into pipe units, which are then linked in the pipe length direction to provide a rehabilitation pipe inside the pipeline. Such a pipe rehabilitation method is used for large-diameter pipelines.

Pipe rehabilitation with a rehabilitation pipe using segments has a drawback due to the minimal internal skeletal structure in the circumferential direction, so that the rehabilitation pipe is prone to deformation in response to outside forces. Therefore, in order to remedy this drawback, it has been proposed to link the segments in the circumferential direction to constitute a pipe unit, to which a restraining member is attached. The restraining member surrounds the outside periphery of the pipe unit to restrain the segments, and prevents deformation due to outside forces (Japanese Patent Laid-Open PCT Publication No. 2006-27939).

According to the rehabilitation pipe disclosed in the above-mentioned Patent Publication, the segments are restrained by wires or bands made of metal or carbon fiber materials. These wires or bands are embedded into the mortar filler that fills a gap between the segmental rehabilitation pipe and the existing pipe, thus enhancing the strength of the composite pipe comprising the existing pipe, the filler, and the segmental rehabilitation pipe. However, in cases in which the wire is made of rebar or the like, the tensile strength will be weak. Therefore, when the composite pipe is subjected to strong external pressure or internal pressure, the composite pipe may experience localized rupture in a section of the filler or rehabilitation pipe, or rupture in its entirety.

Although the strength of the composite pipe may be increased by employing restraining members made of carbon fibers, disadvantages are the high cost of carbon fibers, and difficulty in machining.

### SUMMARY OF THE INVENTION

It is therefore an object of the present invention to provide a rehabilitation pipe that resists deformation due to outside forces and ensures high-strength rehabilitation, and to provide a pipe rehabilitation method employing the rehabilitation pipe.

The present invention provides a rehabilitation pipe for rehabilitating an existing pipe using segments each made of plastic comprising an internal surface panel and integrally formed side and end panels provided at peripheral edges of the internal surface panel. The segments are linked together in a circumferential direction to constitute pipe units, which are linked in succession in a pipe length direction to assemble a rehabilitation pipe. A wire of aramid fibers is attached to the pipe unit such that it loops about the outside periphery thereof. A wire of aramid fibers may be wound in a spiral pattern about the outside periphery of the pipe units that are linked together in the pipe length direction. Alternatively, a band of mesh form made of aramid fibers is attached to the pipe unit such that it loops about the outside periphery thereof.

The present invention also provides a method for rehabilitating an existing pipe using the above-mentioned segments. In the method, the segments are linked in the circumferential direction to constitute a pipe unit, and a wire or a band of mesh form of aramid fibers is attached to the pipe unit such that it loops about the outside periphery thereof. The pipe units with the wire or the band of aramid fibers attached thereto are linked in succession in the pipe length direction to lay a rehabilitation pipe inside an existing pipe. A gap between the rehabilitation pipe and the existing pipe is filled with a filler, which is solidified with the wire or the band being embedded therein.

The wire or the band of aramid fibers may be attached about the entire circumference of the pipe unit each time one of the pipe units is linked in the pipe length direction, and linkage of the pipe units in the pipe length direction and attachment of wires or bands are carried out in succession to thereby lay the rehabilitation pipe inside the existing pipe.

In the method according to the present invention, the pipe units can be linked in succession in the pipe length direction while the wire of aramid fibers is attached in a spiral pattern about the pipe units. Alternatively, a wire of aramid fibers wound into spiral form is disposed inside the existing pipe in a direction extending in the pipe length direction, and the pipe units are linked in succession in the pipe length direction inside the spiral wire to lay a rehabilitation pipe therein.

According to the present invention, a wire or a band comprising aramid fibers is embedded in the filler that fills the gap between the existing pipe and the rehabilitation pipe, and the filler is solidified with the wire or the band embedded therein. This affords a high-strength internal skeletal structure to the rehabilitation pipe, dispersing outside force acting thereon throughout the entire skeletal structure. This thus makes it possible to construct a high-strength composite pipe that resists deformation due to strong internal pressure or external pressure.

### BRIEF DESCRIPTION OF THE DRAWINGS

FIG. 1 is a perspective view showing the structure of a segment for use in assembling a rehabilitation pipe;

FIG. 2 is a sectional view taken along line A-A in FIG. 1, showing a structure for linking segments in the circumferential direction;

FIG. 3 is a perspective view showing segments connected in the circumferential direction to assemble a pipe unit;

FIG. 4 is an illustrative view showing segments of pipe units linked in the pipe length direction;

FIG. 5 is a perspective view of a segment when a wire is attached to the pipe unit;

FIG. 6 is an illustrative view showing a wire looped once about a pipe unit and joined together at both ends;

FIG. 7 is a sectional view of segments along a single linking member of FIG. 4;

FIG. 8 is a sectional view of a segment when viewed on the perpendicular along line B-B of FIG. 7;

FIG. 9 is a front view showing an end panel of a segment;

FIG. 10 is an illustrative view showing a state in which pipe units are assembled to lay a rehabilitation pipe;

FIG. 11 is a perspective view when pipe units have been assembled to lay a rehabilitation pipe inside an existing pipe;

FIG. 12 is a perspective view of segments when a wire has been attached in a spiral pattern to a pipe unit;

FIG. 13 is a perspective view of segments when a wire is to be attached thereto in a spiral pattern to a pipe unit;

FIG. 14 is an illustrative view showing pipe units assembled using a wire that is wound in a spiral pattern;

FIG. 15 is an illustrative view showing pipe units assembled within a wire that is arranged in a spiral pattern; and

FIG. 16 is a perspective view of segments when a band of mesh form has been attached to a pipe unit.

### DESCRIPTION OF THE PREFERRED EMBODIMENTS

The present invention will be described below on the basis of embodiments shown in the accompanying drawings. The present invention is suitable for rehabilitation or repair of large-diameter existing pipes, such as sewer pipes, water pipes, tunnels, agricultural water channels, and the like. In the embodiments, the rehabilitation pipe is described as having a cross sectional shape that is circular viewed orthogonal to the pipe length direction, but it shall be apparent that the present invention can be implemented as well in a rehabilitation pipe of a shape other than circular, such as a rectangular shape or the like. Furthermore, the above-mentioned cross sectional shape is not limited to a closed shape as with a pipe; the present invention can be implemented in the case of a shape open at one side as well, for example, a horseshoe shape, semicircular shape, “U” shape, or the like.

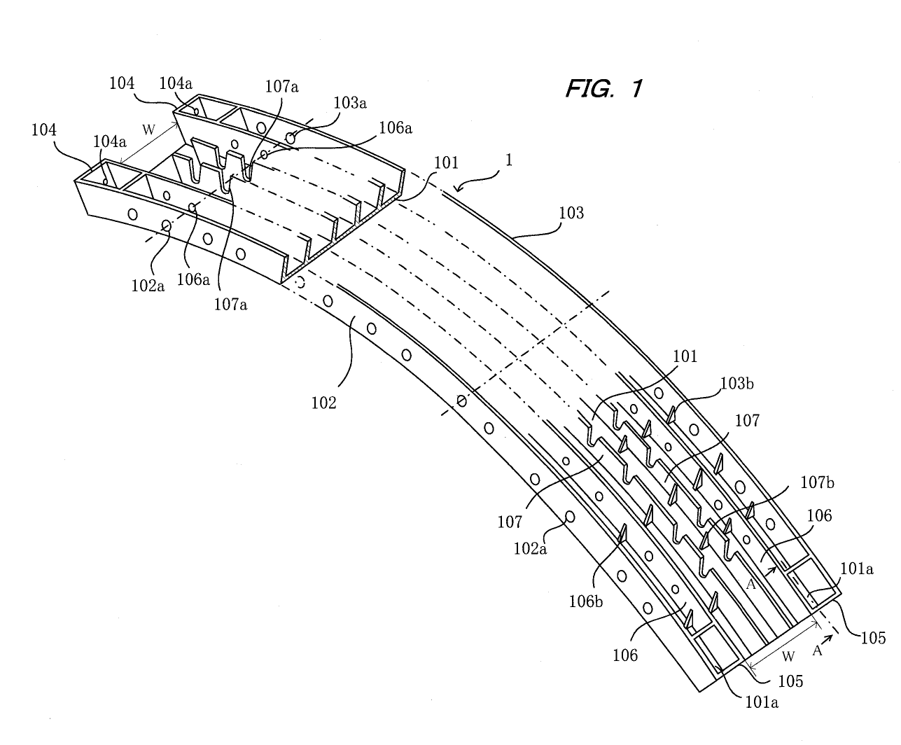

FIG. 1 shows the structure of a segment 1 for a rehabilitation pipe, constituting a unit member for assembly of a rehabilitation pipe for rehabilitation of an existing pipe. The segment 1 is an integrally molded block-shaped member made of a plastic material and composed of an internal surface panel 101 constituting the internal circumferential surface of the rehabilitating pipe, side panels 102, 103 provided vertically at both sides extending in the circumferential direction of the internal surface panel 101, and end panels 104, 105 provided vertically at both ends extending in the pipe length direction of the internal surface panel 101. The side panels 102, 103 and end panels 104, 105 are on four sides at the same height and constitute outer wall panels surrounding the peripheral edges of the internal surface panel 101. As will be discussed below, a medial portion, denoted by W, is missing from the end panels 104, 105, to allow passage of a wire for binding the segments in the circumferential direction.

In the present embodiment, the segment 1 has a shape curved into an arc obtained by dividing the circumference into, e.g., five equal parts at predetermined angles (72°). The segment is not limited to an arc or fan shape, and can also be a rectangular parallelepiped, a curved shape made by providing roundness to right angles, or another shape in accordance with the cross-sectional shape of the existing pipe, the size thereof, or the maintenance locations of the existing pipe.

In cases of reinforcing the mechanical strength of the segment 1, a plurality of internal panels 106, 107 similar to the side panels 102, 103 are provided in parallel therewith on the top surface of the internal surface panel 101 inside of the side panels 102, 103. On the inside surfaces of the side panels 102, 103 and on both side surfaces of the internal panels 106, 107 are formed convex panels 103b, 106b, 107b projecting to the sides at a plurality of locations in order to prevent deformation. This creates a rib structure and increases the strength of the segment 1.

The internal surface panel 101, the side panels 102, 103, the end panels 104, 105, the internal panels 106, 107, and the protruding panels are all made of the same transparent, semi-transparent, or opaque plastic, and have been integrally molded employing molding techniques known in the art.

Two openings 101a for linking segments 1 in the circumferential direction are formed at both ends of the internal surface panel 101, and in order to link the segments 1 in the pipe length direction, a plurality of circular holes 102a, 103a, and 106a are formed in the side panels 102, 103 and internal panel 106, and a plurality of grooves 107a are formed in the internal panels 107.

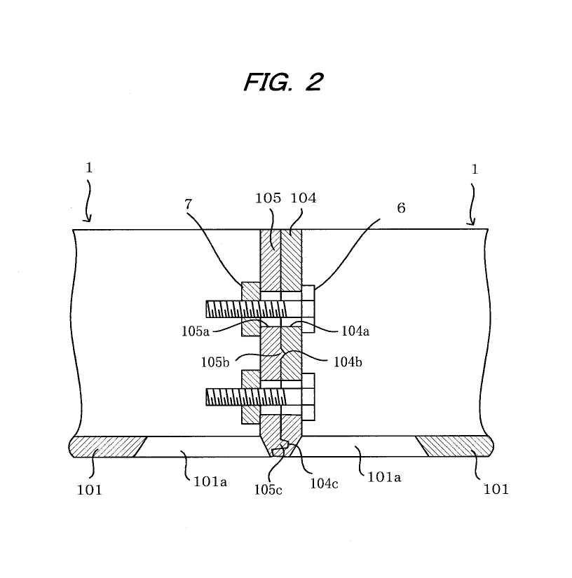

Bolts 6 are inserted into insertion holes 104a, 105a from the openings 101a of the segments 1, and nuts 7 are threaded over the bolts 6 in order to fasten the end panels 104, 105 together and link the segments 1 in the circumferential direction, as shown in FIG. 2. Concavities 104b, 104c are formed across the entire lengths of the end panels 104 in the pipe length direction, and convexities 105b, 105c which fit into the concavities are similarly formed in the end panels 105. Therefore, the operation of positioning and firmly connecting the segments 1 when linking them together is made easier. The watertightness of the linked portions can be increased by coating the fitted portions with a seal material (not shown).

After the segments are finished being linked, the openings 101a are closed using lids (not shown) or other means. The internal surfaces of the lids at this time are continuous with the internal surfaces of each internal surface panel 101 so as to form an even internal surface. In cases in which it is easy to link the segments in the circumferential direction by the bolts 6 and nuts 7, there is no particular need for the openings 101a. Two sets of bolts and nuts are used in FIG. 2, but in the case of segments used for small-diameter existing pipes, the segments can be linked in the circumferential direction by only one set of a bolt and nut.

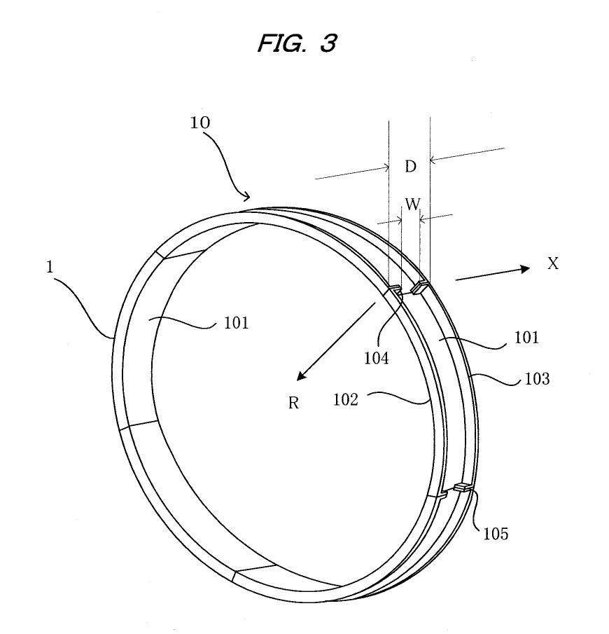

When segments 1 are linked sequentially in the circumferential direction to complete a full circle, a closed ring-shaped short pipe 10 (hereinafter referred to as a pipe unit) of a predetermined short length can be assembled, as shown in FIG. 3. The pipe unit 10 has a shape obtained when a circular pipe is cut into rings of a predetermined width D perpendicular to the pipe length direction X, and the outside diameter thereof is a value slightly less than the inside diameter of the existing pipe to be rehabilitated. The segments 1 correspond to members obtained when the pipe unit 10 is cut in the diametral direction R and divided (preferably equally divided) into a plurality of units in the circumferential direction.

The internal surface panels 101, side panels 102, 103, and end panels 104, 105 are shown in FIG. 3 as primary structural members of the segments 1, and the internal panels 106, 107, convex panels, and other reinforcing structures are not shown for the sake of avoiding complexity.

In this specification, the term “pipe length direction” refers to the direction indicated by the arrow X extending in the pipe length direction of the pipe unit 10 in FIG. 3, the term “diametral direction” refers to the radial direction indicated by the arrow R pointing toward the center axis of the pipe unit 10, and the term “circumferential direction” refers to the circumferential direction of the circle formed by the pipe unit 10.

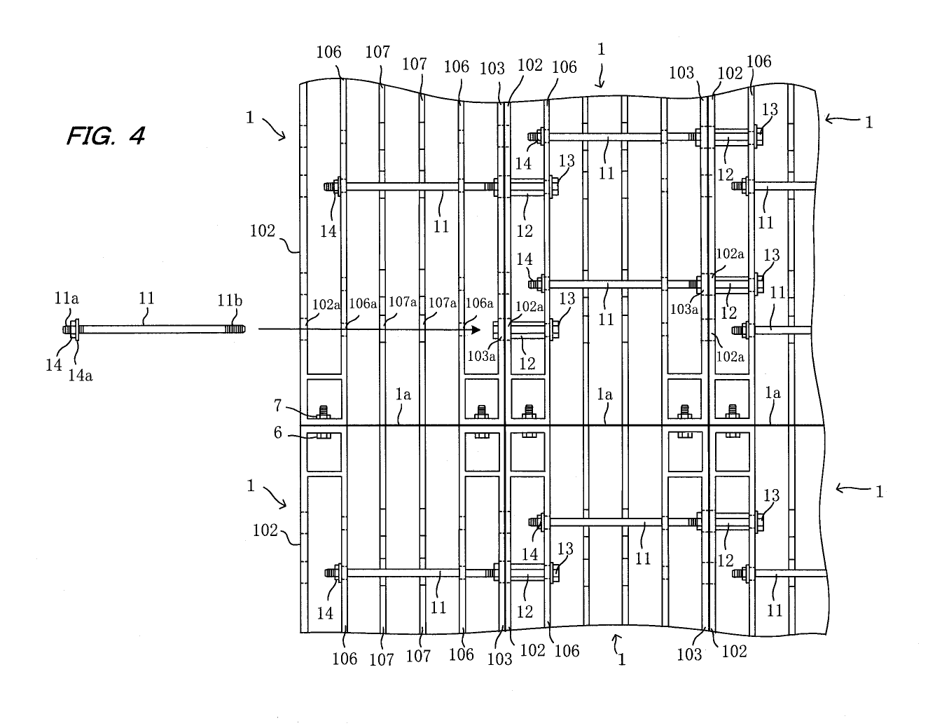

As shown in FIG. 4, linking members (fastening members) 11 and nuts 12 are used to link the segments of the pipe unit 10 to other segments thereof for extension of segments in the pipe length direction.

The nut 12 is passed through a hole 102a in the side panel 102 of one of the segments 1, and is brought into contact with the first internal panel 106, i.e., the one at the position closest from the side panel 102. A bolt 13 is then screwed into the nut 12 to fasten the nut 12 against the internal panel 106 for securing thereto.

The length of the nut 12 in the pipe length direction is a length sufficient to project to the outside beyond the side panel 102 of the segment 1, and the amount of projection thereof is the same as or greater than the thickness of the side panel 103 of the other segment 1, so that the nut 12 may be passed through the hole 103a of the side panel 103 of the other segment 1 in order to butt the two segments 1 together.

In this state, the linking member 11 is passed through the hole 102a of the side panel 102 of the segment 1, the holes 106a of the internal panels 106, and the notches 107a of the internal panels 107, and a thread portion 11b of the linking member 11 is screwed into the nut 12 secured to one of the segments 1 to connect the linking member 11 and the nut 12. Thereafter, a nut 14 is screwed on the linking member 11 until a flange 14a thereof is pressed against the internal panel 106 at the leftmost end, thereby fastening and securing the two segments 1, 1.

A plurality of the nuts 12 are secured to a single segment in the circumferential direction, e.g., are secured every other hole 102a of the side panel 102, or are secured every plurality of holes in accordance with the required strength. Each segment is connected so that the nut position in a first segment is offset as viewed in the circumferential direction from the nut position of a second segment that is adjacent to the first segment. In the example as shown in FIG. 4, the position of the nuts 12 in the center-positioned segment 1 is, as viewed in the circumferential direction, offset by a single hole 102a of the side panel 102 from the position of the nuts 12 in the segment 1 adjacent to the right side panel thereof. By having the positions of the nuts differ in an adjacent segment in this manner, the arrangement of the linking members and the nuts becomes staggered as viewed in its entirety.

The segments of a pipe unit are thus linked to the segments of another pipe unit to extend the rehabilitation pipe to any desired length in the pipe length direction.

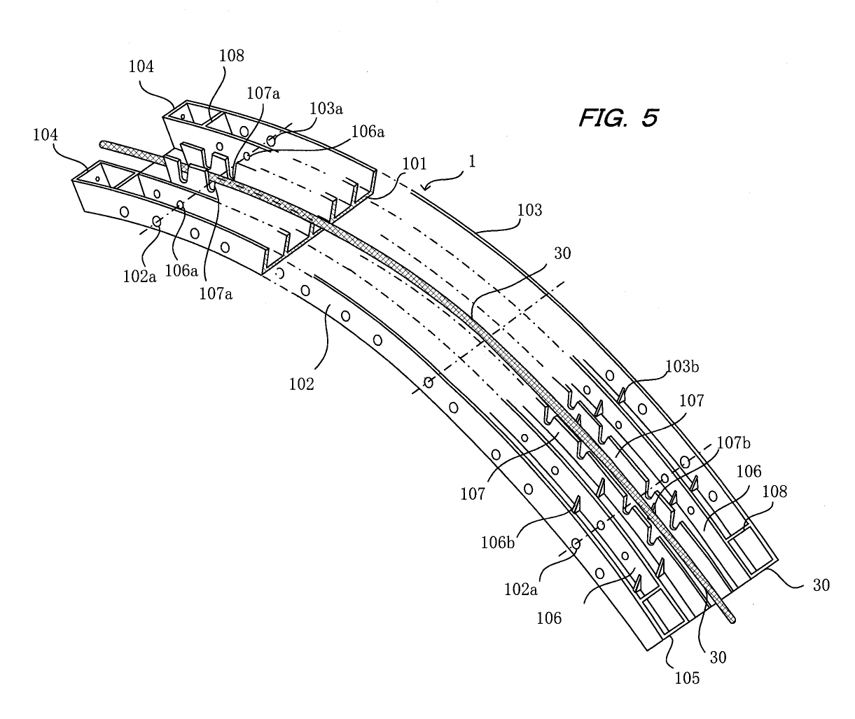

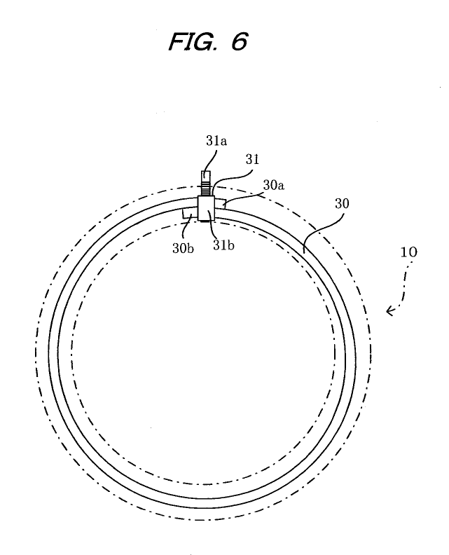

In the present embodiment, as shown in FIGS. 5 and 6, a high-strength, high-elasticity wire member, for example, a wire 30 of substantially circular cross section comprising aramid fibers is attached to the pipe unit 10 to bind it in order to increase the strength thereof. Aramid fibers were developed by the Toray-DuPont company, and are marketed under the trade name KEVLAR™. Aramid fibers are especially high in strength and high in elasticity, and are characterized by exceedingly high tensile strength. The aramid fibers are woven as a wire in a braided pattern (developed by Fibex Inc.). In the present embodiment, the wire 30 of woven aramid fibers is attached about the pipe unit. A wire may be fabricated by weaving aramid fibers in a braided pattern and coating silica thereon (developed by Fibex Inc.).

As shown in FIG. 5, the wire 30 is disposed between the two internal panels 107 of the segments to complete a circle in the circumferential direction in the substantial center of the pipe unit 10 as viewed in the pipe length direction. As shown in FIG. 6, the ends 30a, 30b of the wire 30 are juxtaposed and linked by a link fitting 31. The link fitting 31 is a commercially marketed link fitting designed with a narrow strip 31a in which are formed teeth like saw teeth. The strip 31a is passed through a hole in a box 31b in which are formed inverted teeth. The inverted teeth of the box 31b and the teeth of the strip 31a are induced to mesh, thereby fastening and linking together the ends 30a, 30b of the wire 30. The two ends 30a, 30b can also be linked together and bound with ordinary cording, rather than such a link fitting 31. As discussed below, the wire 30 is to be embedded in a filler such as grout or mortar filled between the rehabilitation pipe and the existing pipe, and is secured within the filler. Therefore, the linkage of the ends 30a, 30b of the wire 30 may be a temporary one.

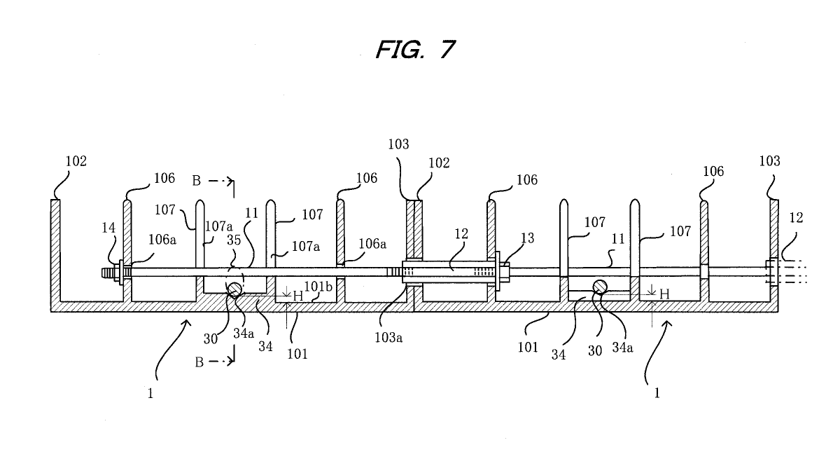

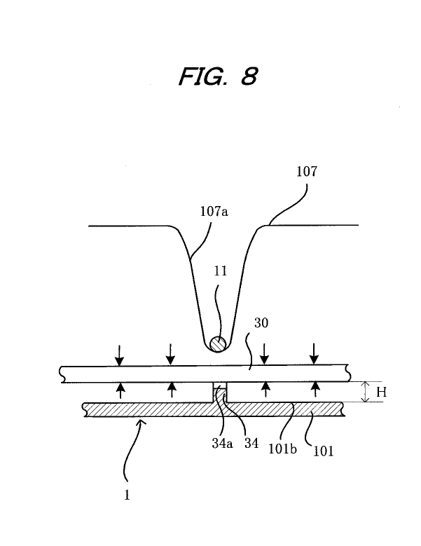

As shown in FIGS. 7 and 8, guide members 34 that protrude perpendicularly from the plane 101b of the internal surface panel 101 are formed between the internal panels 107 integrally therewith. This allows the bottom end of the attached wire 30 to be separated by a predetermined height H from the plane 101b of the internal surface panel 101 of the segment when the wire 30 is attached to the pipe unit 10. Guide slots 34a are formed in these guide members 34, and the wire 30 is attached so as to be accommodated within the guide slots 34a. The above-mentioned H will be determined such that the wire 30 is attached at a position lower than the linking members 11 that link together the segments in the pipe length direction.

A plurality of these guide members 34 are provided in the circumferential direction of the segments 1, preferably below the positions at which the linking members 11 are present, as shown in FIGS. 7 and 8. At this time, the wire 30 may be attached in simple fashion by banding together the wire 30 and the linking members 11 with cordage or rope 35.

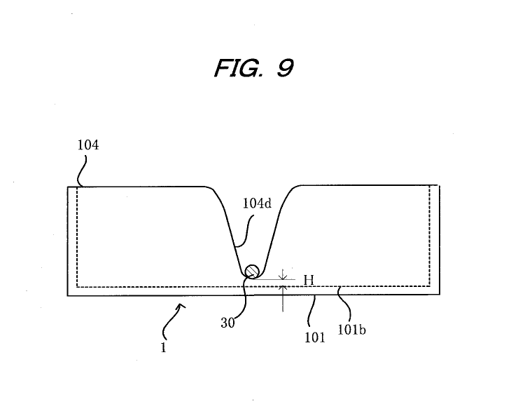

In a case in which the wire 30 is to be attached to the pipe unit 10 in a manner separated from the plane 101b, guide portions 104d having a guide slot are formed on the end panel 104 of the segments 1 at a height H from the plane 101b of the internal surface panel 101, as shown in FIG. 9. This allows the wire 30 to be attached in a manner separated by H from the plane 101b of the internal surface panel 101. Guide portions comparable to the guide portions 104d of the end panel 104 are provided to the other end panel 105 as well.

The method for rehabilitating an existing pipe employing the rehabilitation pipe constituted in this manner is now described.

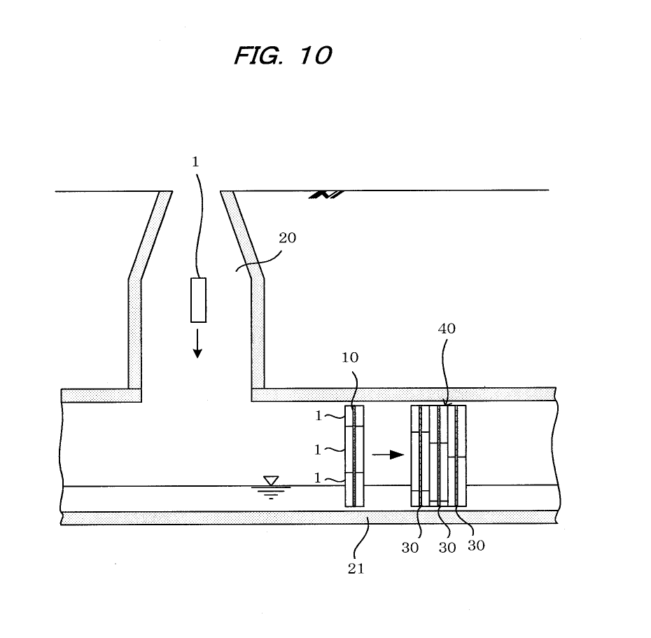

As shown in FIG. 10, firstly, the segments 1 are transported into an existing pipe 21 via a manhole 20, and the segments 1 are linked in succession in the circumferential direction to assemble the pipe units 10 as shown in FIGS. 2 and 3. Next, as shown in FIGS. 5 and 6, a wire 30 composed of aramid fibers is attached to each of the pipe units 10 in a complete circle about the outside periphery thereof. At this time, as shown in FIGS. 7 and 8, the wire 30 is attached in a state separated by height H from the plane of the internal surface panel facing toward the existing pipe.

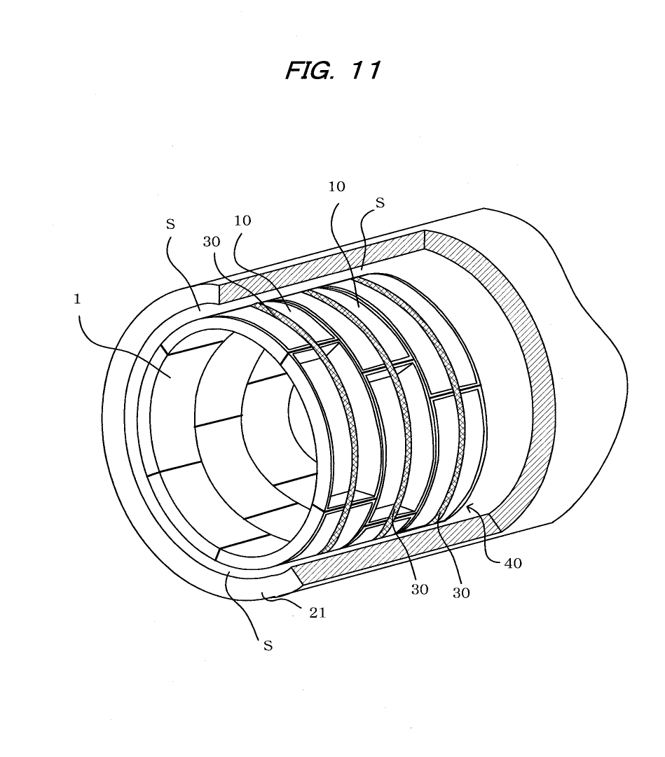

Next, the pipe units 10 to which the wires 30 have been attached are linked in succession in the pipe length direction by the linking members 11 using the method shown in FIG. 4, and a rehabilitation pipe 40 is laid inside the existing pipe 21 as shown in FIGS. 10 and 11.

Next, a gap S between the rehabilitation pipe 40 and the existing pipe 21 is filled with a filler such as grout or the like, the wires 30 are embedded in the filler, and the filler is solidified. In FIGS. 10 and 11, the linking members 11 and so forth have been omitted, and the segments are depicted in simplified fashion.

Thus, a composite pipe in which the existing pipe 21 and the rehabilitation pipe 40 are firmly bonded by the filler can be constructed. When filling the space between the existing pipe 21 and the rehabilitation pipe 40 with the filler, the filler fills to the upper side and the lower side of the wires 30 as shown by arrows in FIG. 8, and therefore the filler is present in all directions around the wires 30. The solidification of the filler allows the wires 30 to be firmly secured within the filler and integrally bonded therewith. Since the wires 30 are made of aramid fibers of extremely high tensile strength, it is possible to provide high-strength rehabilitation that is resistant to deformation, even when the composite pipe is subjected to strong external pressure or internal pressure.

In the embodiment discussed above, the pipe units are linked in succession in the pipe length direction after the wires 30 have been attached thereto. However, it would be acceptable as well to link the pipe units 10 in the pipe length direction employing the linking members 11 prior to attaching the wires 30 thereto. In this case, each time a pipe unit is linked in the pipe length direction, the wire 30 is attached about the entire circumference of the pipe unit 10 just linked. Linkage of the pipe units in the pipe length direction and attachment of wires are carried out in succession to lay a rehabilitation pipe inside an existing pipe. In this case as well, when the space between the existing pipe 21 and the rehabilitation pipe 40 is filled with the filler, the filler is present in all directions around the wires 30, and the solidification of the filler allows the wires 30 to be firmly secured within the filler, making possible a high-strength rehabilitation that is resistant to deformation, even when the composite pipe is subjected to strong outside pressure or internal pressure.

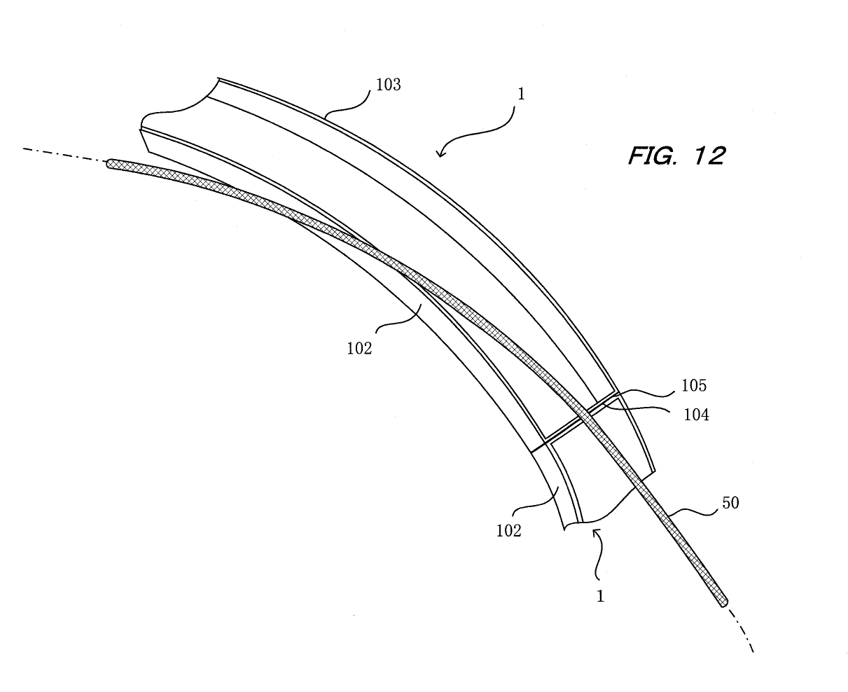

In the above-mentioned embodiment, the wire 30 is looped once around the entire circumference of the pipe unit 10, and the two ends thereof are fastened to form a single wire of substantially circular shape. However, the wire may instead take spiral form for attachment to the pipe units in continuous fashion. Such an embodiment is shown in FIGS. 12 to 14.

Like the wires 30, a wire 50 is made of aramid fibers, and, as shown in FIG. 12, is wound in spiral fashion at a predetermined helical pitch so as to rest on the side panels 102, 103, and the end panels 104, 105 of the segments 1 of the pipe units. In this case, the end panels 104, 105 have the shape of continuous single panels of identical height without the missing section W as shown in FIG. 1.

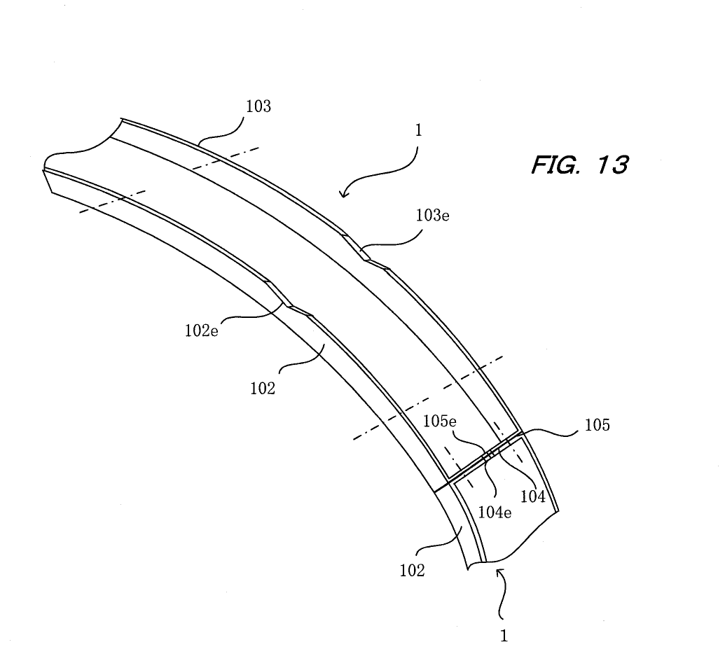

As shown in FIG. 13, in order to lay the wire 50 in spiral form about the segments, guide slots 102e, 103e, 104e, 105e for guiding the wire 50 into spiral form are formed at the top of the side panels 102, 103, and the end panels 104, 105 of the segments 1 of the pipe units. As shown by the hypothetical lines in FIG. 13, when these guide slots are formed at a plurality of locations, it is possible to attach the wire 50 at differing helical pitch. In cases in which the internal panels 106, 107 are present, guide slots for guiding the wire 50 into spiral form would be formed in similar fashion at the top thereof as well.

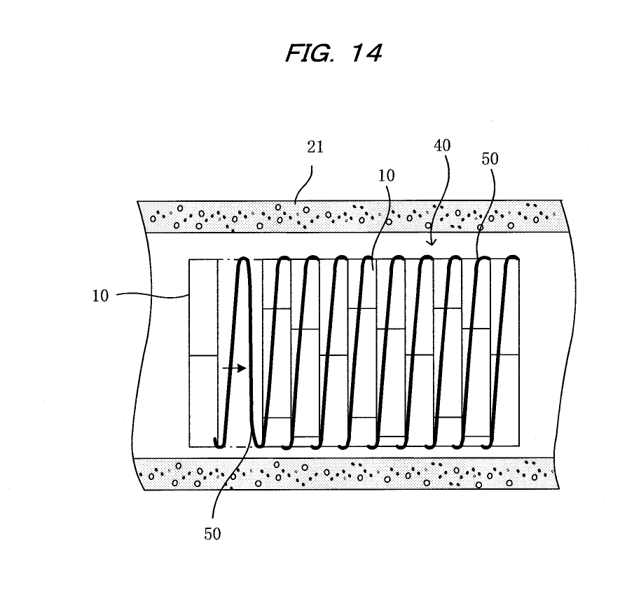

To rehabilitate an existing pipe using such a wire 50 of spiral form, the segments 1 are linked together in the circumferential direction to assemble the pipe units 10. Then, as shown in FIG. 14, the pipe units 10 are linked together in succession in the pipe length direction using the linking members, while attaching the wire 50 in spiral form about the pipe units. Thus, a rehabilitation pipe 40 to which the wire 50 is attached in continuous fashion in spiral form about the outside periphery thereof is laid inside the existing pipe 21. The wire 50 may be attached to another pipe unit after the pipe unit concerned has been linked by a linking member 11 to a pipe unit about which the wire 50 is already wound; or a pipe unit about which a wire has been arranged in spiral form beforehand may be linked by a linking member to a pipe unit about which the wire 50 is already wound.

The gap between the laid rehabilitation pipe 40 and the existing pipe 21 is then filled with a filler such as grout, the wire 50 of spiral form is embedded in the filler, and the filler is solidified. In this case, the entire wire 50 is embedded in the filler, making it possible to construct a high-strength composite pipe that experiences negligible deformation even when subjected to strong outside pressure or internal pressure.

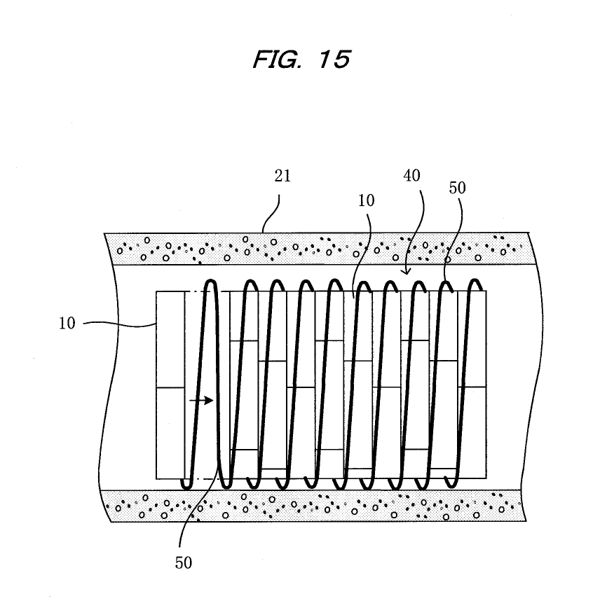

As shown in FIG. 15, the wire 50 may also be disposed beforehand within the existing pipe 21 so as to extend in spiral form in the pipe length direction. In this case, the wire 50 arranged in spiral form is joined to anchors (not shown) which have been secured to the existing pipe, and the pipe units 10 are successively linked together in the pipe length direction inside the spiral wire 50 to lay the rehabilitation pipe 40 inside the existing pipe 21. In this case, although the wire 50 is not attached in close contact with the rehabilitation pipe 40, the wire 50 becomes integrally joined to the filler when embedded in the filler and solidified therewith. This also makes it possible to construct a high-strength composite pipe that experiences negligible deformation even when subjected to strong outside pressure or internal pressure.

In this embodiment, since the wire 50 takes a continuous spiral form, there is no need to fasten together the two ends of the wire each time that a wire is attached to a pipe unit, as with the previous embodiment.

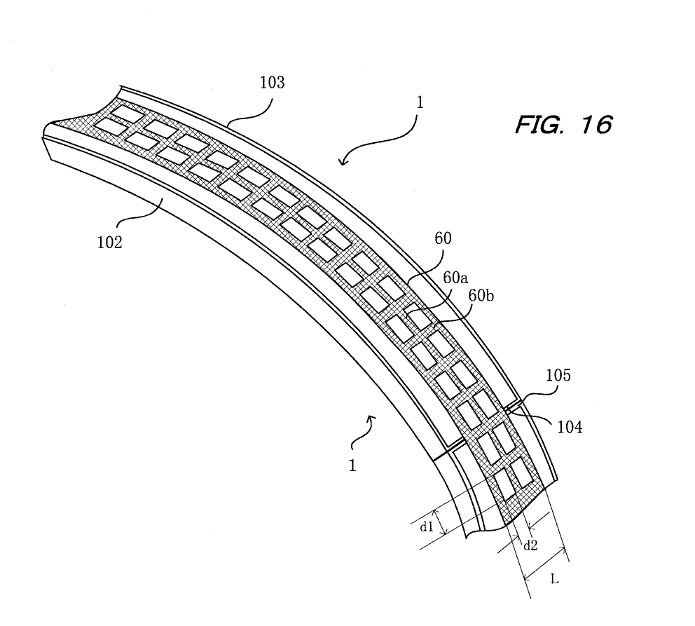

FIG. 16 shows another embodiment in which a band 60 of mesh form comprised of aramid fibers is attached to the segments and the pipe units in place of wires of linear form.

The band 60 has a width L in the pipe length direction, and a length sufficient to loop once about the entire circumference of the pipe unit 10. With two ends thereof fastened via a link fitting 31 in the same manner as the wire 30, it is attached to the pipe unit in a shape that binds the pipe unit. Since the band 60 is attached so as to rest on the upper end of the end panels 104, 105 of the segments 1, the end panels 104, 105 have the shape of continuous single panels of identical height without the missing section W as shown in FIG. 1. The band 60 of width L has a mesh structure in which a plurality of d1×d2 rectangular hollow areas is formed.

In a case in which rehabilitation is to be carried out employing the band 60 having this mesh structure, in the same manner as when the wire 30 is employed, the segments 1 are linked together in the circumferential direction to provide the pipe unit 10, and the band 60 is looped once around the outside periphery of the pipe unit and attached thereto. Next, the pipe units 10 with the bands 60 attached thereto are linked together in succession in the pipe length direction to lay the rehabilitation pipe 40 inside the existing pipe 21. The gap between the rehabilitation pipe 40 and the existing pipe 21 is then filled with a filler such as grout, the band 60 is embedded in the filler, and the filler is solidified.

The bands 60 can be attached after the pipe units have been linked together in the pipe length direction. In this case, a band 60 is attached about the entire circumference of the pipe unit 10 each time that a pipe unit is linked in the pipe length direction. The linkage of the pipe units in the pipe length direction and attachment of the bands are performed in succession to lay the rehabilitation pipe inside the existing pipe. Then, the gap between the rehabilitation pipe and the existing pipe is filled with a filler, the band is embedded in the filler, and the filler is solidified.

In a case in which bands 60 of mesh form are used, the aramid fibers are present not only in the circumferential direction 60a but also in the pipe length direction 60b of the band 60, and therefore in cases in which the band 60 is embedded in the filler, the composite pipe of the existing pipe and the rehabilitation pipe joined by the filler will be endowed with high tensile strength not only in the circumferential direction but also in the pipe length direction, making it possible to construct a high-strength composite pipe that experiences negligible deformation even when subjected to strong outside pressure or internal pressure.

The mesh structure of the band 60 is not limited to rectangular shape as shown in FIG. 16. Mesh structures are also acceptable in which other shapes, such as diamond shapes, circular shapes, and the like, are present in large numbers. The band width L may be a width that is coextensive with the entire width of the segments 1 in the pipe length direction (the width of the end panels).

In cases in which a wire of spiral form is embedded in the filler in continuous fashion and fastened along the pipe length direction, or in cases in which bands of mesh form are embedded in the filler, the strength of the composite pipe comprising the existing pipe and the rehabilitation pipe integrally joined via the filler is exceedingly high, and therefore it is not essential for the material of the wire or band to be aramid fibers, so rebar, other iron materials, or other metals may be acceptable. Consequently, it would be acceptable to construct the rehabilitation pipe by attaching to the rehabilitation pipe a metal wire that extends in continuous fashion in spiral form in the pipe length direction, or by attaching a band of mesh structure made of metal about the entire circumference of the pipe unit. Since the wire of spiral form or the band of mesh structure is embedded and secured in the filler filled between the existing pipe and the rehabilitation pipe, a high-strength composite pipe can be constructed in like fashion.

What is claimed is:

1. A rehabilitation pipe for rehabilitating an existing pipe using segments each made of plastic comprising an internal surface panel and integrally formed side and end panels provided at peripheral edges of the internal surface panel, the segments being linked together in a circumferential direction to constitute pipe units, which are linked in succession in a pipe length direction to assemble a rehabilitation pipe, wherein a wire of aramid fibers is attached to the pipe unit such that it loops about the outside periphery thereof.

2. The rehabilitation pipe according to claim 1, wherein a guide member is attached to the existing pipe side of the internal surface panel of the segment, and the wire is attached so as to be separated by the guide member at a predetermined height from the existing pipe side of the internal surface panel.

3. The rehabilitation pipe according to claim 1, wherein a guide portion is formed on the end panel of the segment, and the wire is attached so as to be separated by the guide portion at a predetermined height from the existing pipe side of the internal surface panel.

4. The rehabilitation pipe according to claim 1, wherein the wire is attached at a position lower than a linking member for linking the segments in the pipe length direction.

5. A rehabilitation pipe for rehabilitating an existing pipe using segments each made of plastic comprising an internal surface panel and integrally formed side and end panels provided at peripheral edges of the internal surface panel, the segments being linked together in a circumferential direction to constitute pipe units, which are linked in succession in a pipe length direction to assemble a rehabilitation pipe, wherein a wire of aramid fibers is wound in a spiral pattern about the outside periphery of the pipe units that are linked together in the pipe length direction.

6. The rehabilitation pipe according to claim 5, wherein a guide slot for guiding the wire into spiral form is formed at the top of the side panels and end panels of the segments.

7. A rehabilitation pipe for rehabilitating an existing pipe using segments each made of plastic comprising an internal surface panel and integrally formed side and end panels provided at peripheral edges of the internal surface panel, the segments being linked together in a circumferential direction to constitute pipe units, which are linked in succession in a pipe length direction to assemble a rehabilitation pipe, wherein a band of mesh form of aramid fibers is attached to the pipe unit such that it loops about the outside periphery thereof.

8. The rehabilitation pipe according to claim 7, wherein the band has a mesh structure such that the aramid fibers extend in the pipe length direction and the circumferential direction.

9. A method for rehabilitating an existing pipe using segments each made of plastic comprising an internal surface panel and integrally formed side and end panels provided at peripheral edges of the internal surface panel, the method comprising:
linking the segments in the circumferential direction to constitute a pipe unit;
attaching to the pipe unit a wire of aramid fibers that loops about the outside periphery thereof;
linking in succession the pipe units with the wire attached thereto in the pipe length direction to lay a rehabilitation pipe inside an existing pipe; and
filling a gap between the rehabilitation pipe and the existing pipe with a filler, which is solidified with the wire being embedded therein.

10. The method according to claim 9, wherein the wire is attached so as to be separated by a predetermined height from the existing pipe side of the internal surface panel.

11. The method according to claim 9, wherein the wire is attached at a position lower than a linking member for linking the segments in the pipe length direction.

12. A method for rehabilitating an existing pipe using segments each made of plastic comprising an internal surface panel and integrally formed side and end panels provided at peripheral edges of the internal surface panel, the method comprising:
linking the segments in the circumferential direction to constitute a pipe unit;
linking the pipe units in the pipe length direction using a linking member;
attaching a wire of aramid fibers about the entire circumference of the pipe unit each time one of the pipe units is linked in the pipe length direction;
carrying out in succession linkage of the pipe units in the pipe length direction and attachment of wires to lay a rehabilitation pipe inside an existing pipe; and
filling a gap between the rehabilitation pipe and the existing pipe with a filler, which is solidified with the wire being embedded therein.

13. A method for rehabilitating an existing pipe using segments each made of plastic comprising an internal surface panel and integrally formed side and end panels provided at peripheral edges of the internal surface panel, the method comprising:
linking the segments in the circumferential direction to constitute a pipe unit;
linking the pipe units in succession in the pipe length direction while a wire of aramid fibers is attached in a spiral pattern about the pipe units, thereby laying inside an existing pipe a rehabilitation pipe around which the wire is wound in a spiral pattern; and
filling a gap between the rehabilitation pipe and the existing pipe with a filler, which is solidified with the spiral wire being embedded therein.

14. A method for rehabilitating an existing pipe using segments each made of plastic comprising an internal surface panel and integrally formed side and end panels provided at peripheral edges of the internal surface panel, the method comprising:
disposing inside an existing pipe a wire of aramid fibers wound into spiral form in a direction extending in the pipe length direction;
linking the segments in the circumferential direction to constitute a pipe unit;
linking the pipe units in succession in the pipe length direction inside the wire wound into spiral form, thereby laying a rehabilitation pipe inside the spiral wire; and
filling a gap between the rehabilitation pipe and the existing pipe with a filler, which is solidified with the spiral wire being embedded therein.

15. A method for rehabilitating an existing pipe using segments each made of plastic comprising an internal surface panel and integrally formed side and end panels provided at peripheral edges of the internal surface panel, the method comprising:
linking the segments in the circumferential direction to constitute a pipe unit;
attaching to the pipe unit a band of mesh form of aramid fibers that loops about the outside periphery thereof;
linking in succession the pipe units with the band attached thereto in the pipe length direction to lay a rehabilitation pipe inside an existing pipe; and
filling a gap between the rehabilitation pipe and the existing pipe with a filler, which is solidified with the band being embedded therein.

16. A method for rehabilitating an existing pipe using segments each made of plastic comprising an internal surface panel and integrally formed side and end panels provided at peripheral edges of the internal surface panel, the method comprising:
linking the segments in the circumferential direction to constitute a pipe unit;
linking the pipe units in the pipe length direction using a linking member;
attaching a band of mesh form of aramid fibers about the entire circumference of the pipe unit each time one of the pipe units is linked in the pipe length direction;
carrying out in succession linkage of the pipe units in the pipe length direction and attachment of bands to lay a rehabilitation pipe inside an existing pipe; and
filling a gap between the rehabilitation pipe and the existing pipe with a filler, which is solidified with the band being embedded therein.
